(19) United States
(12) Patent Application Publication
(10) Pub. No.: US 2025/0131823 A1
(43) Pub. Date: Apr. 24, 2025

(54) MESH NETWORK OF SENSORS FOR SMART VEHICLES

(71) Applicant: DERQ Inc., Tortola (VG)

(72) Inventor: Ankit Sharma, Dubai (AE)

(21) Appl. No.: 18/891,820

(22) Filed: Sep. 20, 2024

Related U.S. Application Data
(60) Provisional application No. 63/539,972, filed on Sep. 22, 2023.

(51) Int. Cl. G08G 1/0967; G06V 20/54; G06V 20/58; G08G 1/01; G08G 1/04

(52) U.S. Cl. CPC G08G 1/096766; G06V 20/54; G06V 20/582; G08G 1/0116; G08G 1/04; G06V 2201/08

(57) ABSTRACT

A system includes an array of sensors configured to capture data about an environment for vehicular traffic. The array of sensors is disposed at a non-vehicular location. The system also includes one or more computing devices that include one or more processors. The one or more processors are configured to process the captured data about the environment to detect one or more road users in the environment and/or to detect information about traffic signage in the environment. The one or more processors are also configured to transmit, in real-time, an indication of the one or more detected road users and/or the detected information about the traffic signage in the environment to a vehicle.

### CLAIM OF PRIORITY

This application claims priority under 35 USC § 119(e) to U.S. patent application Ser. No. 63/539,972, filed on Sep. 22, 2023, the entire contents of which are hereby incorporated by reference.

### TECHNICAL FIELD

This specification relates to the deployment of sensors in road environments and scenarios to improve the situational awareness of smart vehicles and to provide real-time insights relating to road environments/scenarios.

### BACKGROUND

In recent years, the automotive industry has witnessed a significant transformation with the advent of autonomous and connected vehicles. Connected vehicles or “smart vehicles” are an emerging technology that refers to vehicles that can connect to a computer network, for example, to establish a wireless communication with other vehicles or with roadside infrastructure (e.g., roadside base stations). These advancements have been fueled by the integration of cutting-edge technologies such as sensors, artificial intelligence (AI), and communication systems.

### SUMMARY

This document describes techniques for leveraging the strategic installation of sensors in road environments and scenarios to capture a wide range of information about road users, terrain features, and traffic elements. By doing so, a comprehensive and dynamic data ecosystem and a mesh network of sensors can be created that can (i) enable vehicles to navigate and interact with their surroundings more intelligently, and (ii) enable real-time alerts and analytics relating to the road environment. This paradigm shift in how data is gathered and utilized to make informed decisions in road environments/scenarios is referred to herein as “Detections as a Service” (DaaS). Various implementations of the systems and related methods described in this document can have many advantages over existing techniques.

First, the technology disclosed herein can enhance vehicle perception and autonomy compared to vehicles that rely solely on onboard sensors to gather information about the local environment. For example, by performing sensor fusion, vehicle sensor data can be combined with data from other nearby sensors in the road environment to overcome blind spots, limited sensing capabilities, and potential sensor malfunctions.

The technology disclosed herein also has the advantage of enabling the provision of real-time alerts and analytics that have not previously been available (at least not with the same level of accuracy). Examples of such alerts and analytics include traffic management, predictive maintenance services, and safety notifications.

To support the foregoing advantages over existing techniques, the technology disclosed herein further provides advantages including (i) more efficient and accurate approaches for performing latency compensation in Intelligent Transportation Systems (ITS); and (ii) novel techniques for mapping pixel coordinates in images to GPS coordinates for enhancing the accuracy and efficiency in geolocation mapping for computer vision applications.

In one aspect, a system is featured. The system includes an array of sensors configured to capture data about an environment for vehicular traffic, the array of sensors disposed at a non-vehicular location. The system also includes one or more computing devices including one or more processors. The one or more processors are configured to process the captured data about the environment to detect one or more road users in the environment and/or to detect information about traffic signage in the environment. The one or more processors are also configured to transmit, in real-time, an indication of the one or more detected road users and/or the detected information about the traffic signage in the environment to a vehicle.

Implementations can include the examples described below and herein elsewhere. In some implementations, the one or more processors can be further configured to identify static or dynamic terrain information about the environment. In some implementations, transmitting the indication of the one or more detected road users and/or the detected information about the traffic signage in the environment to the vehicle can include transmitting the indication directly to the vehicle. In some implementations, transmitting the indication of the one or more detected road users and/or the detected information about the traffic signage in the environment to the vehicle can include transmitting the indication to the vehicle via a cloud server.

In another aspect, another system is featured. The system includes an array of sensors configured to capture data about an environment for vehicular traffic, the array of sensors disposed remotely from the vehicle. The system also includes one or more computing devices including one or more processors. The one or more processors are configured to process the captured data about the environment to detect one or more road users in the environment and/or to detect information about traffic signage in the environment. The one or more processors are also configured to transmit, in real-time, an indication of the one or more detected road users and/or the detected information about the traffic signage in the environment to a service provider that provides real-time alerts and/or analytics to vehicle owners based on the transmitted indication.

Implementations can include the examples described below and herein elsewhere. In some implementations, the one or more processors can be further configured to identify static or dynamic terrain information about the environment. In some implementations, transmitting the indication of the one or more detected road users and/or the detected information about the traffic signage in the environment to the service provider can include transmitting the indication directly to the service provider. In some implementations, transmitting the indication of the one or more detected road users and/or the detected information about the traffic signage in the environment to the service provider can include transmitting the indication to the service provider via a cloud server. In some implementations, the real-time alerts and/or analytics can relate to traffic management, predictive maintenance, and/or safety notifications.

In another aspect, a method is featured. The method includes capturing data about an environment for vehicular traffic using an array of sensors; and processing the captured data, using one or more processors, to detect one or more road users in the environment and/or to detect information about traffic signage in the environment. The method also includes transmitting, in real-time, an indication of the one or more detected road users and/or the detected information about the traffic signage in the environment to a vehicle in the road environment.

Implementations can include the examples described below and herein elsewhere. In some implementations, the method can include processing the captured data, using the one or more processors, to identify static or dynamic terrain information about the environment. In some implementations, transmitting the indication of the one or more detected road users and/or the detected information about the traffic signage in the environment to the vehicle can include transmitting the indication directly to the vehicle. In some implementations, transmitting the indication of the one or more detected road users and/or the detected information about the traffic signage in the environment to the vehicle can include transmitting the indication to the vehicle via a cloud server.

In another aspect, a method for performing latency compensation is featured. The method includes determining a latency due to a processing delay and a sensor delay associated with an array of sensors configured to capture data about an environment for vehicular traffic. The method also includes predicting a trajectory of one or more road entities based on (i) historical data and real-time data captured by the array of sensors and (ii) the determined latency. The method also includes applying the predicted trajectory in real-time to compensate for the latency.

Implementations can include the examples described below and herein elsewhere. In some implementations, determining the latency due to the processing delay can include looking up a fixed value for the processing delay at a particular set of working conditions. In some implementations, determining the latency due to the sensor delay can include conducting tests to measure a time between data capture and data transmission for specific sensor types under different working conditions. In some implementations, predicting the trajectory of the one or more road entities can include utilizing at least one of a Kalman filter, a particle filter, or a machine learning model.

In another aspect, a method for GPS mapping an image view is featured. The method includes synchronizing, for a plurality of selected points, GPS data coordinates recorded by a GPS receiver and image pixel coordinates associated with an image view captured by a visual-based sensor. The method also includes interpolating GPS data coordinate values for all remaining image pixel coordinates within the image view captured by the visual-based sensor.

Implementations can include the examples described below and herein elsewhere. In some implementations, interpolating the GPS data coordinate values for all the remaining image pixel coordinates within the image view captured by the visual-based sensor can include utilizing Delaunay Triangulation. In some implementations, synchronizing the GPS data coordinates recorded by the GPS receiver and the image pixel coordinates associated with the image view can include: (i) detecting when the GPS receiver is in a location that is within a field of view of the visual-based sensor; (ii) identifying an image pixel coordinate corresponding to the GPS receiver while the GPS receiver is at the location; and (iii) associating the image pixel coordinate corresponding to the GPS receiver with GPS data coordinates recorded by the GPS receiver while the GPS receiver is at the location.

In another aspect, a system for GPS mapping of image views is featured. The system includes a GPS receiver, an image sensor, and one or more computing devices that include one or more processors. The one or more processors are configured to synchronize, for a plurality of selected points, GPS data coordinates recorded by the GPS receiver and image pixel coordinates associated with an image view captured by the image sensor. The one or more processors are also configured to interpolate GPS data coordinate values for all remaining pixel coordinates within the image view captured by the image sensor.

Other features and advantages of the description will become apparent from the following description, and from the claims. Unless otherwise defined, the technical and scientific terms used herein have the same meaning as commonly understood by one of ordinary skill in the art to which this invention belongs.

### BRIEF DESCRIPTION OF THE DRAWINGS

FIG. 1 is a diagram of a roadside environment including a sensor deployment.

FIG. 2 is a diagram illustrating an event timeline.

FIG. 3 is a flowchart of an example process for performing latency compensation.

FIG. 4 is a diagram illustrating GPS mapping of an image view.

FIG. 5 is a flowchart of an example process for GPS mapping of an image view.

FIG. 6 is a diagram illustrating an example of a computing environment.

### DETAILED DESCRIPTION

“Detections as a Service” (DaaS) is an emerging concept that is poised to redefine the way vehicles perceive and interact with their surroundings. This innovative approach involves the deployment of sensor arrays across various road scenarios, enabling vehicles to access real-time and accurate data about their environment. By subscribing to this service, vehicle owners can enhance the situational awareness of their vehicles, facilitate autonomous driving, and improve overall road safety.

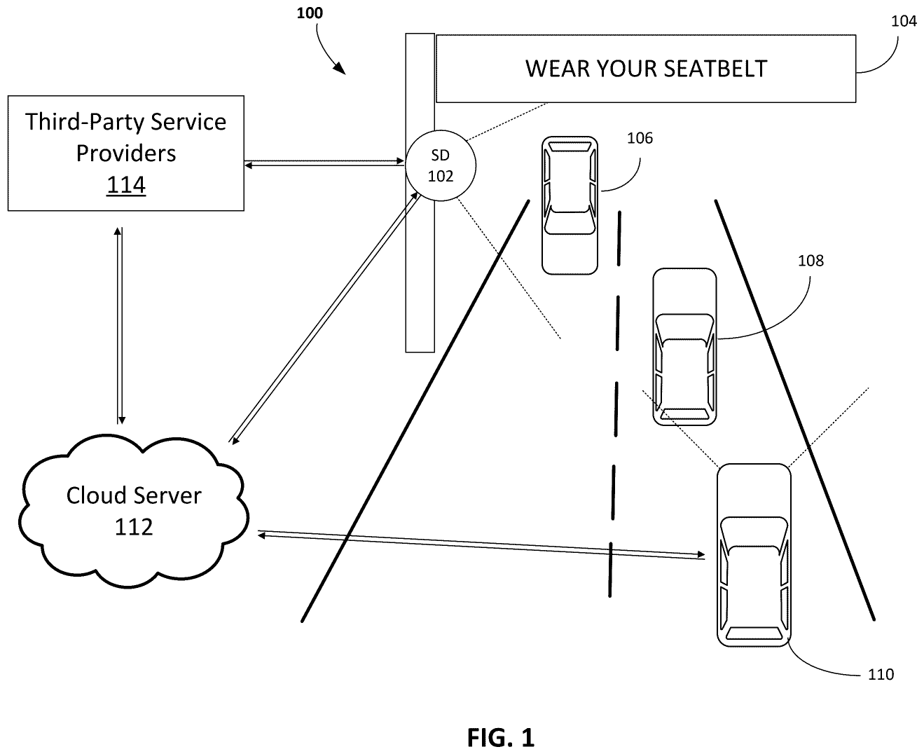

Referring to FIG. 1, a sensor deployment (SD) 102 can include an array of sensors capable of detecting both vehicles (e.g., vehicles 106, 108, 110) and vulnerable road users (VRUs) within a specific range of distances and field of view from the SD 102. SDs may encompass static placements along road segments or within traffic and building infrastructure. However, they can also take on a mobile or temporary configuration, potentially involving (autonomous) vehicles and movable trailers as qualifying examples. SDs in the vicinity of a road environment/scenario 100 (e.g., on a traffic sign, on a highway median, on a roadside lamppost, etc.) can provide information about a range of distances and can detect all road users (vehicles and VRUs) along with the details of static or dynamic terrain information and traffic signage information, and more. This comprehensive dataset can provide vehicles with a more holistic understanding of their environment, which is crucial for safe and efficient autonomous operation. As described below, this dataset can also be used to provide real-time analytics and alerts to vehicle owners and other third parties alike. Examples of road environment/scenarios where SDs can be implemented include urban settings, suburban settings, highway setting, compound settings, etc.

When there is an array of SDs, these SDs can be strategically positioned in the road environment/scenario and can be connected to each other to create a mesh network of road entity information nodes. The SDs can share information with each other when required. These SDs may also be connected to a central server or a series of central servers.

DaaS holds the potential to revolutionize the way vehicles interact with their environment, paving the way for a future of intelligent and connected mobility. By leveraging SDs strategically positioned across different road scenarios, vehicles can access a wealth of real-time and accurate data that empowers them to navigate autonomously and safely. Furthermore, the concept of DaaS extends its benefits beyond individual vehicles, offering opportunities for various service providers to harness the data for innovative solutions. Whether it's optimizing traffic flow, enabling predictive maintenance, or enhancing road safety, DaaS creates a dynamic and collaborative ecosystem that thrives on the exchange of information.

As technology continues to advance and the automotive industry embraces the era of autonomous and connected vehicles, Detections as a Service has the potential to shape the future of transportation. Through seamless data integration, intelligent sensor networks, and innovative applications, DaaS is poised to redefine mobility, making it safer, more efficient, and more intelligent than ever before.

### Enhancing Vehicle Perception and Autonomy

In one example application of DaaS, a vehicle (e.g., the vehicle 110 shown in FIG. 1) in the road environment/scenario 100 can include onboard sensors that are capable of detecting road users (e.g., vehicle 108) up to some distance. However, these onboard sensors have limitations in detection performance due to blind spots, limited sensor capability, and sensor malfunctions. For example, referring to FIG. 1, the vehicle 110 may not be able to detect the oncoming vehicle 106 because the vehicle 106 is not within a field of view of vehicle 110's onboard sensors. To increase the accuracy and reliability of its data about road users and surroundings (including but not limited to, road terrain, traffic signs and traffic light information), the vehicle 110 can supplement its own onboard sensor data by subscribing to the data generated by an SD 102 or multiple SDs. In this manner, the vehicle 110 can act as “connected vehicle” or “smart vehicle.” The vehicle can require data indicative of at least up to a variable distance D for the vehicle to be able to operate autonomously, with the variable distance D depending on the speed of the vehicle 110 and the road environment/scenario 100. The data from the SDs (e.g., SD 102) in the vicinity of the road environment/scenario 100 can help supply this data and can be combined with the vehicle 110′s onboard sensor data using sensor fusion techniques. In some cases, the vehicle 110 itself can be considered a SD (e.g., a moving SD) based on its array of onboard sensors, and the vehicle can interact with other SDs in the environment 100 in a substantially similar manner as any other SD.

There are many means to relay the information generated by the SDs (e.g., the SD 102) to the vehicle 110. Two prominent approaches are (i) point-to-point transmission of information and (ii) cloud-based transmission. In the point-to-point transmission approach, sensor data and/or other information captured by the SDs are directly sent to the vehicle. In the cloud-based transmission approach (shown in FIG. 1), the sensor data and/or other information captured by the SDs (e.g., SD 102) are uploaded to one or more servers (e.g., cloud server 112), where they are then accessed by the vehicle 110. Different means of communication have different advantages and disadvantages, including differences in latencies. When such latencies are measurable, they can and should be compensated, as described in further detail herein to ensure the vehicles receive timely and relevant information. In short, however, the sensor data provided by the SDs (e.g., SD 102) can be provided to the vehicle 110 (or to other third parties such as third party service providers 114) in real-time.

To create a seamless flow of information, multiple SDs can be interconnected, forming a mesh network of road entity information nodes. These nodes can share data among themselves, ensuring that each SD remains updated with the latest information from the mesh network. Additionally, SDs can establish connections with central servers or a network of distributed servers (e.g., cloud server 112), enabling efficient data exchange and enhancing the overall accuracy and availability of road-related data.

One challenge of implementing SDs for enhancing vehicle perception and autonomy is that the integration of SD-generated data with onboard sensor data requires sophisticated sensor fusion techniques. Sensor fusion is important since by combining data from different sources, vehicles can make informed decisions that are more accurate and robust, thus enhancing their ability to navigate complex scenarios and unexpected road conditions. Examples of techniques for improving sensor fusion—such as GPS mapping of image views from SD—are further discussed below.

### Enabling Real-time Alert and Analytics

Beyond enhancing vehicle autonomy, the benefits of Detections as a Service (DaaS) can extend to various stakeholders, including third-party service providers 114. For example, in another example, the data collected by SDs can be made available to different third-party service providers 114, enabling them to access real-time alerts and perform advanced analytics. These providers can then use this data to offer a wide range of services, such as traffic management, predictive maintenance, and safety notifications. With respect to real-time alerts, data collected from SDs (e.g., SD 102) can be provided to various service providers 114 who can offer real-time alerts to vehicles (e.g., alerts about road conditions, potential obstacles, or traffic situations). With respect to analytics, the data collected form SDs can also be analyzed to gain insights into traffic patterns, road user behavior, and other relevant information. For instance, a traffic management service could utilize real-time data from SDs to optimize traffic flow and reduce congestion. Similarly, a predictive maintenance service could monitor road conditions and vehicle behavior to anticipate potential mechanical issues, ensuring timely maintenance and reducing the risk of breakdowns. The availability of real-time alerts and analytics not only enhances road safety and efficiency but also opens up new avenues for innovation and business opportunities within the automotive ecosystem.

The concept of DaaS facilitates the creation of a more robust and comprehensive autonomous driving ecosystem by leveraging external sensor deployments to enhance the capabilities of vehicles. This not only improves the safety and accuracy of autonomous vehicles but also opens up opportunities for real-time alerts and data-driven analytics in the transportation domain. Different communication methods and sensor fusion techniques play a crucial role in making this concept practical and effective.

### Latency Compensation

Intelligent Transportation Systems (ITS) represent a technological leap in the way transportation networks are managed and optimized. However, as mentioned above, it is important to deal with the various sources of latency that can affect the accuracy and timeliness of information transmitted within the system. Latency compensation techniques play a crucial role in addressing these challenges by mitigating the impact of delays introduced by sensors and processing units.

In ITS environments (e.g., the road environment 100), a multitude of road entities, such as vehicles (e.g., vehicles 106, 108, 118), pedestrians, and infrastructure components (e.g., traffic sign 104), interact to form a complex network. These entities may communicate their kinetic information through sensors and communication systems, both connected and non-connected. In scenarios where entities lack their own communication setups or possess varying levels of temporal precision, the system must bridge the gap in time to ensure accurate and synchronized data exchange. Latency compensation can therefore be a key feature to maintain the integrity and reliability of the ITS infrastructure.

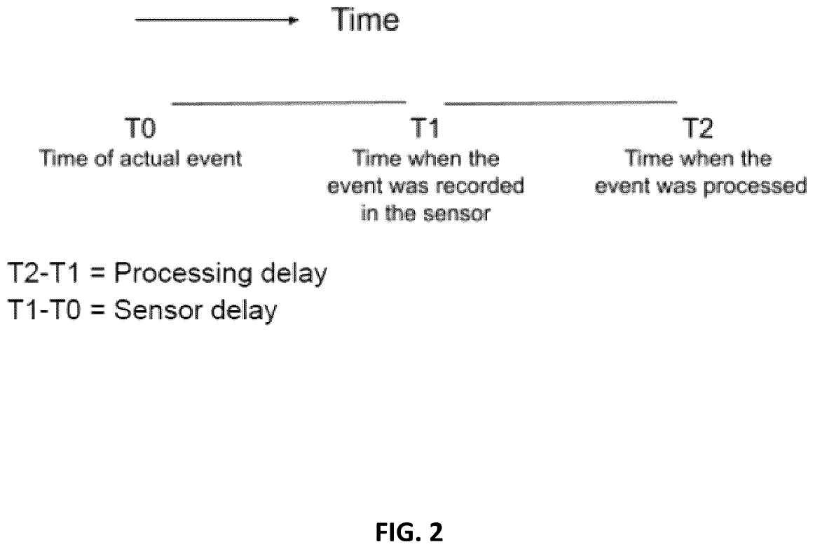

A typical ITS environment includes a sensor setup (e.g., the SD 102) that captures data from the surroundings. Referring to FIG. 2, this setup can introduce two main types of time delays. First, the setup can introduce a processing delay (T2-T1), which arises from the time it takes to process the data received from the SD. Factors affecting processing delay include the computational power of the processing unit, object density in the environment, temperature conditions, and more. Second, the setup can introduce a sensor delay (T1-T0). Sensor delay refers to the time lag between data captured by the sensor and its transmission to the processing unit. This delay can be influenced by the characteristics of the sensor technology and may vary based on different working conditions. As shown in FIG. 2, T0 can represent the time of the actual recorded event, T1 can represent the time when the even was recorded in the sensor (e.g., the SD), and T2 can represent the time when the event was processed.

Efficient latency compensation requires accurate calculation and benchmarking of the delays introduced by the sensor setup. In some implementations, the processing delays and sensor delays described above can be calculated and can have fixed values for specific working conditions. To determine the processing delay, various factors such as the complexity of object recognition algorithms, data fusion techniques, and the processing unit's hardware capabilities need to be considered. Computational power, memory, object density, temperature, and the utilization of parallel processing can also impact the time taken to process sensor data. Benchmarking sensor delay, on the other hand, involves conducting controlled lab tests to measure the time between data capture and transmission for specific sensor types under different conditions. This data can then be used to establish fixed values for sensor delays in various scenarios.

In some implementations, an environment may have a mix of road entities (e.g., vehicles, pedestrians, etc.) where some entities send their kinetic information with temporal precision while for other non-connected entities, a separate SD determines and sends the entity's kinetic information. In such situations, the system has to compensate for the delays that are introduced through this process. The latency compensation can be done by using various methods of trajectory predictions and applying those in real time.

Latency compensation can be achieved through trajectory prediction methods that leverage historical and real-time data to estimate the future positions and behaviors of road entities. These predictions help bridge the temporal gap and ensure that the transmitted information aligns with the current state of the environment.

Various prediction algorithms, such as Kalman filters, particle filters, and machine learning models, can be employed to forecast the future trajectories of entities. These methods, referred to herein as “trajectory prediction” methods” take into account factors like velocity, acceleration, road conditions, and historical movement patterns to generate accurate predictions.

Once trajectory predictions are generated, they are applied in real-time to compensate for the time delays. The system adjusts the received information based on the predicted positions, allowing for synchronized and timely updates of entity data. The implementation of latency compensation technique in ITS offers a range of benefits including enhanced safety, optimized traffic flow, efficient resource allocation, and accurate decision-making. With respect to enhanced safety, latency compensation ensures that accurate and up-to-date information is available to one or more entities in the transportation network, contributing to improved safety measures and collision avoidance. With respect to optimized traffic flow, synchronized data transmission and compensation can help optimize traffic flow by providing real-time insights into congestion, road conditions, and potential bottlenecks. With respect to efficient resource allocation, reduced temporal discrepancies can allow for transportation authorities to allocate resources more effectively, such as adjusting traffic signal timings and managing emergency responses. With respect to accurate decision-making, latency compensation enables informed decision-making for both human drivers and automated systems, enhancing overall traffic management and navigation. In general, the efficacy and benefits of latency compensation are largely driven by the accuracy of trajectory predictions, the reliability and quality of input data from sensors such as those in SDs (e.g., highlighting the importance of sensor calibration, maintenance, and data fusion strategies), and communication infrastructure that allow for robust and real-time transmission of updated trajectory predictions to various road entities (e.g., through the leveraging of advanced communication networks like 5G networks). In some cases, latency compensation can be further improved through edge computing, for example, by distributing processing capabilities closer to sensors in order to minimize processing delays and enable faster decision-making.

Latency compensation finds application in various ITS scenarios. With respect to connected and autonomous vehicles (CAVs), CAVs rely on accurate and timely data to make split-second decisions. Latency compensation ensures that CAVs receive relevant information without being hindered by processing and sensor delays. With respect to traffic management systems, latency compensation contributes to the effectiveness of traffic management systems by providing real-time data on traffic conditions and enabling adaptive traffic control strategies. With respect to pedestrian safety, latency compensation ensures that vehicles can respond promptly to pedestrians' movements to detect pedestrians and avoid collisions. With respect to emergency services, timely information delivery can be critical for emergency response vehicles since latency compensation can aid in reducing response times and optimizing routes.

Latency compensation is a pivotal concept within the realm of Intelligent Transportation Systems, addressing the challenges posed by time delays introduced by sensor setups and processing units. By accurately predicting the trajectories of road entities and synchronizing data transmission, latency compensation enhances safety, traffic management, and decision-making in the transportation network. As technology continues to advance, the application of latency compensation techniques will play a crucial role in shaping the future of efficient and interconnected transportation systems.

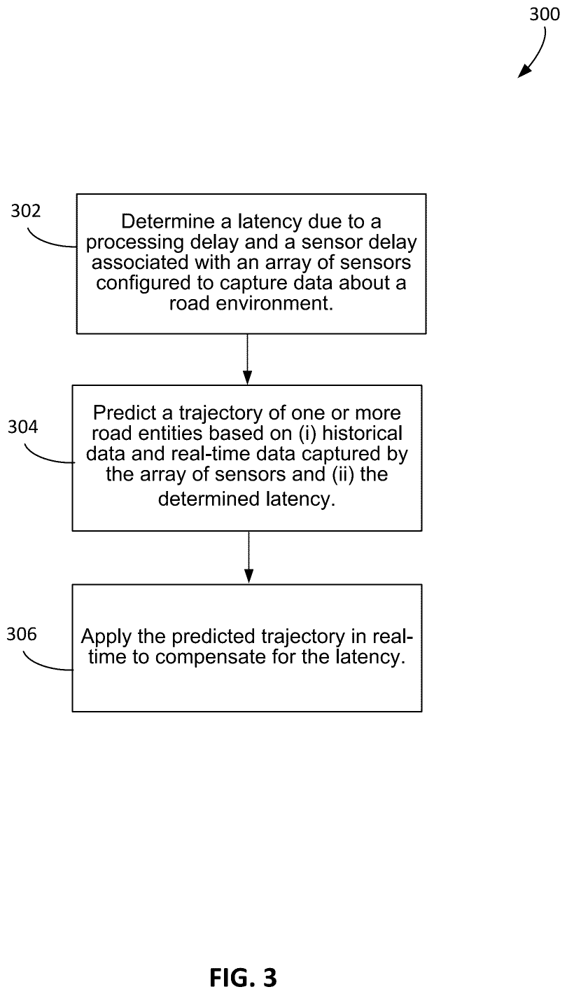

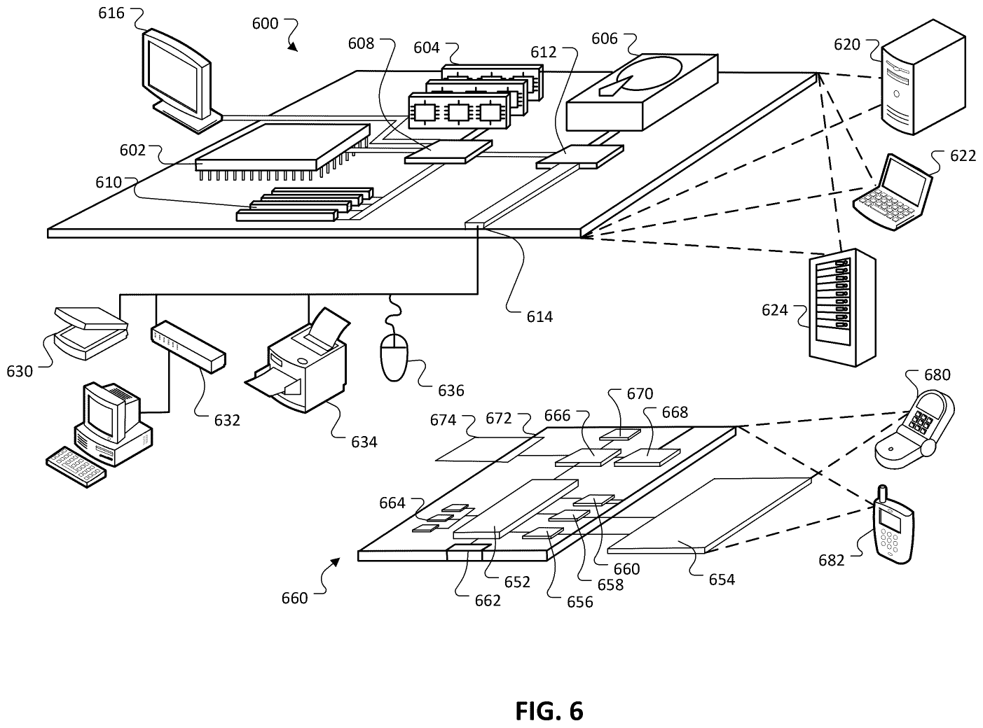

Referring now to FIG. 3, a process 300 for monitoring industrial equipment is shown and described. In some implementations, the operations of the process 300 can be executed by a sensor deployment (e.g., SD 102 shown in FIG. 1) or a computing device connected to a SD. Examples of such computing devices are described in relation to FIG. 6.

Operations of the process 300 include determining a latency due to a processing delay and a sensor delay associated with an array of sensors configured to capture data about a road environment (302). For example, the latency, the processing delay, and the sensor delay can correspond to those described above in relation to FIG. 2. In some implementations, determining the latency due to the processing delay can include looking up a fixed value for the processing delay at a particular set of working conditions. In some implementations, determining the latency due to the sensor delay can include conducting tests to measure a time between data capture and data transmission for specific sensor types under different working conditions.

Operations of the process 300 also include predicting a trajectory of one or more road entities based on (i) historical data and real-time data captured by the array of sensors and (ii) the determined latency (304). In some implementations, as described above in relation to FIG. 2, predicting the trajectory of the one or more road entities can include utilizing at least one of a Kalman filter, a particle filter, or a machine learning model.

Operations of the process 300 also include applying the predicted trajectory in real-time to compensate for the latency (306).

### GPS Mapping of Image Views

In addition to implementing latency compensation, another important part of implementing Intelligent Transportation Systems (as described above) is the ability to perform sensor fusion. To that end, this specification discloses a novel method and system for achieving GPS mapping of image views, thereby establishing a robust connection between pixel coordinates within an image and their corresponding GPS coordinates in the real world. This innovative technology encompasses data collection processes, interpolation methodologies, practical applications, challenges, and considerations for enhanced accuracy and efficiency in geolocation mapping for computer vision applications. In today's interconnected world, the fusion of geolocation data and imagery holds immense significance across various domains, including but not limited to computer vision, sensor networks, navigation, autonomous vehicles and augmented reality. Accurate GPS mapping of image views forms the foundation for numerous applications reliant on precise spatial alignment between the virtual and real worlds, and in the context of ITS, can be used to relate various coordinate systems, for example, of SDs disposed in different locations to allow for sensor fusion.

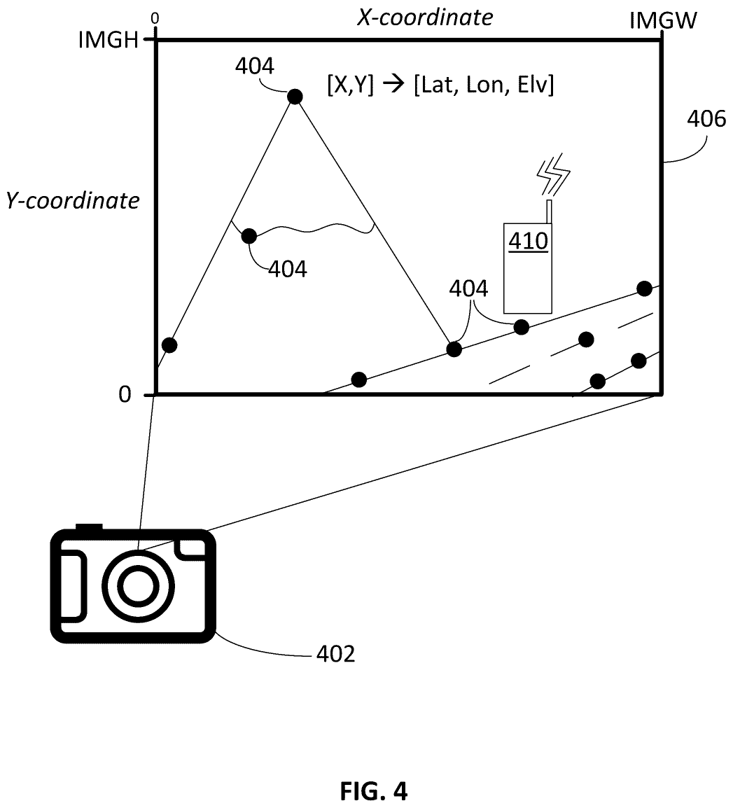

Referring to FIG. 4, to perform GPS mapping of image views, a data synchronization mechanism is employed to record GPS receiver data and image pixel coordinates simultaneously. This synchronized data forms the basis for mapping. For example, for a camera (e.g., camera 402) or other vision-based sensor looking at an intersection, specific, easily identifiable points (e.g., points 404) in the camera field of view can be selected to provide the best results for overall mapping and are close to the region of interest in the field of view. Importantly, a sufficient density and distribution of the selected points 404 can be identified to ensure that weight is given to all areas within the image view (e.g., in the image 406). Each selected point in the image 406 can correspond to an image pixel coordinate [X,Y] where 0<X<IMGW and 0<Y<IMGH, and where IMGW represents the image width in pixels and IMGH represents the image height in pixels. Using a GPS receiver (e.g., the GPS receiver 410), a real-world GPS location can also be determined for each selected point in the image, for example, assigning each point a GPS data coordinate of [Lat, Lon, Elv] where Lat represents the latitude of the point, Lon represents the longitude of the point, and Elv represents the elevation of the point. In some implementations, to associate a GPS data coordinate with the image pixel coordinate, the camera 402 (or other sensor) can detect when the GPS receiver 410 is in the field of view and identify an image pixel coordinate for the GPS receiver 410 at that location. This image pixel coordinate can be associated with the GPS data coordinates recorded by the GPS receiver 410 at the same location, thereby establishing a mapping between the GPS data coordinate and the image pixel coordinate at a given point. The GPS receiver can then be moved and the process repeated for each point selected in the data synchronization process.

Next, after establishing the GPS data coordinate and image pixel coordinate mappings for a sufficient number of selected points 404, an interpolation technique can be employed to interpolate latitude (Lat), longitude (Lon), and elevation (Elv) values for all other pixel coordinates within the image view. For example, in some implementations the interpolation technique can involve utilizing Delaunay Triangulation. That is, Delaunay Triangulation can be used for a subset of sample data [X, Y] to determine a Lat value for the full range of X and Y. Similarly, Delaunay Triangulation can be used for a subset of sample data [X,Y] to determine a Lon value for the full range of X and Y. And finally, Delaunay Triangulation can be used for a subset of sample data [Lat, Lon] to determine an Elv value for the full range of Lat and Lon determined in the preceding steps.

The GPS mapping of image views can find application in diverse fields including sensor deployments, augmented reality, navigation, autonomous driving, geographic information systems (GIS), disaster response, agriculture, and precision farming. In some implementations, the GPS mapping of image views can utilize one or more machine learning models for data synchronization or interpolation, to enhance mapping accuracy through feature extraction from the image views, and/or to perform temporal analysis of the GPS data. Furthermore, in some implementations, the GPS mapping of image views can utilize error estimation and correction mechanisms to address error propagation. In some implementations, the GPS mapping of image views can enable real-time mapping capabilities (e.g., making the technique suitable for applications such as autonomous vehicles and robotics). In some implementations, the GPS mapping of image views can involve using multiple SDs for multi-sensor fusion (e.g., integrating data from cameras, LiDAR, and/or inertial sensors to improve geolocation accuracy). In some implementations, the GPS mapping of image views can include utilizing edge computing for latency reduction.

The novel and innovative solution for GPS mapping of image views described in this document addresses the challenges and considerations associated with accurate geospatial alignment and has the potential to revolutionize the way geolocation information is harnessed for various applications in our connected world.

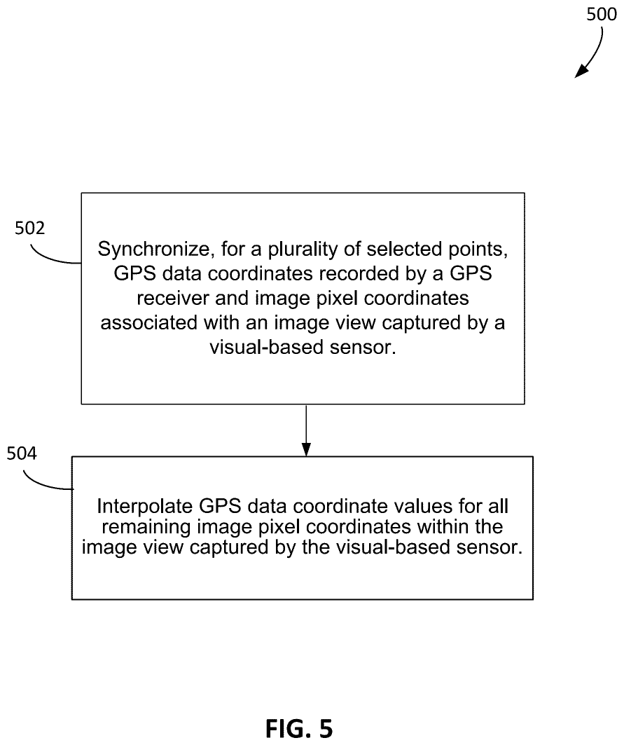

Referring now to FIG. 5, a process 500 for GPS mapping an image view is shown and described. In some implementations, the operations of the process 500 can be executed by a computing device that is in communication with a visual-based sensor such as the camera 402. Examples of such computing devices are described in relation to FIG. 6 below.

Operations of the process 500 include synchronizing, for a plurality of selected points, GPS data coordinates recorded by a GPS receiver and image pixel coordinates associated with an image view captured by a visual-based sensor (502). For example, the plurality of selected points can correspond to the points 404 shown in FIG. 4, and the GPS receiver can correspond to the GPS receiver 410. In some implementations, the GPS data coordinates can be of the form [Lat, Lon, Elv] and the image pixel coordinates can be in the form of [X,Y], as described above. In some implementations, synchronizing the GPS data coordinates recorded by the GPS receiver and the image pixel coordinates associated with the image view can include: (i) detecting when the GPS receiver is in a location that is within a field of view of the visual-based sensor; (ii) identifying an image pixel coordinate corresponding to the GPS receiver while the GPS receiver is at the location; and (iii) associating the image pixel coordinate corresponding to the GPS receiver with GPS data coordinates recorded by the GPS receiver while the GPS receiver is at the location.

Operations of the process 500 also include interpolating GPS data coordinate values for all remaining image pixel coordinates within the image view captured by the visual-based sensor (504). In some implementations, interpolating the GPS data coordinate values for all the remaining image pixel coordinates within the image view captured by the visual-based sensor can include utilizing Delaunay Triangulation, as described above in relation to FIG. 4.

FIG. 6 shows an example of a computing device 600 and a mobile computing device 650 that are employed to execute implementations of the present disclosure. For example, the computing device 600 and/or the mobile computing device 650 can correspond to computing devices such as those described above and can be employed to execute various steps of the processes 300 and 500 including steps 302, 304, 306, 502, and 504. In some implementations the cloud server 112, SDs such as SD 102, and even smart vehicles (e.g., the vehicle 110) can operate as computing devices. In some implementations multiple computing devices may be used to jointly perform the operations disclosed above in a distributed manner (e.g., via cloud computing). It is also recognized that computing tasks performed jointly by multiple computing devices can be redistributed amongst the multiple computing devices without limitation, unless otherwise specified in this document.

The computing device 600 is intended to represent various forms of digital computers, such as laptops, desktops, workstations, personal digital assistants, servers, blade servers, mainframes, and other appropriate computers. The mobile computing device 650 is intended to represent various forms of mobile devices, such as personal digital assistants, cellular telephones, smart-phones, AR devices, and other similar computing devices. The components shown here, their connections and relationships, and their functions, are meant to be examples only, and are not meant to be limiting.

The computing device 600 includes a processor 602, a memory 604, a storage device 606, a high-speed interface 608, and a low-speed interface 612. In some implementations, the high-speed interface 608 connects to the memory 604 and multiple high-speed expansion ports 610. In some implementations, the low-speed interface 612 connects to a low-speed expansion port 614 and the storage device 604. Each of the processor 602, the memory 604, the storage device 606, the high-speed interface 608, the high-speed expansion ports 610, and the low-speed interface 612, are interconnected using various buses, and may be mounted on a common motherboard or in other manners as appropriate. The processor 602 can process instructions for execution within the computing device 600, including instructions stored in the memory 604 and/or on the storage device 606 to display graphical information for a graphical user interface (GUI) on an external input/output device, such as a display 616 coupled to the high-speed interface 608. In other implementations, multiple processors and/or multiple buses may be used, as appropriate, along with multiple memories and types of memory. In addition, multiple computing devices may be connected, with each device providing portions of the necessary operations (e.g., as a server bank, a group of blade servers, or a multi-processor system).

The memory 604 stores information within the computing device 600. In some implementations, the memory 604 is a volatile memory unit or units. In some implementations, the memory 604 is a non-volatile memory unit or units. The memory 604 may also be another form of a computer-readable medium, such as a magnetic or optical disk.

The storage device 606 is capable of providing mass storage for the computing device 600. In some implementations, the storage device 606 may be or include a computer-readable medium, such as a floppy disk device, a hard disk device, an optical disk device, a tape device, a flash memory, or other similar solid-state memory device, or an array of devices, including devices in a storage area network or other configurations. Instructions can be stored in an information carrier. The instructions, when executed by one or more processing devices, such as processor 602, perform one or more methods, such as those described above. The instructions can also be stored by one or more storage devices, such as computer-readable or machine-readable mediums, such as the memory 604, the storage device 606, or memory on the processor 602.

The high-speed interface 608 manages bandwidth-intensive operations for the computing device 600, while the low-speed interface 612 manages lower bandwidth-intensive operations. Such allocation of functions is an example only. In some implementations, the high-speed interface 608 is coupled to the memory 604, the display 616 (e.g., through a graphics processor or accelerator), and to the high-speed expansion ports 610, which may accept various expansion cards. In the implementation, the low-speed interface 612 is coupled to the storage device 606 and the low-speed expansion port 614. The low-speed expansion port 614, which may include various communication ports (e.g., Universal Serial Bus (USB), Bluetooth, Ethernet, wireless Ethernet) may be coupled to one or more input/output devices. Such input/output devices may include a scanner, a printing device, or a keyboard or mouse. The input/output devices may also be coupled to the low-speed expansion port 614 through a network adapter. Such network input/output devices may include, for example, a switch or router.

The computing device 600 may be implemented in a number of different forms, as shown in FIG. 6. For example, it may be implemented as a standard server 620, or multiple times in a group of such servers. In addition, it may be implemented in a personal computer such as a laptop computer 622. It may also be implemented as part of a rack server system 624. Alternatively, components from the computing device 600 may be combined with other components in a mobile device, such as a mobile computing device 650. Each of such devices may contain one or more of the computing device 600 and the mobile computing device 650, and an entire system may be made up of multiple computing devices communicating with each other.

The mobile computing device 650 includes a processor 652; a memory 664; an input/output device, such as a display 654; a communication interface 666; and a transceiver 668; among other components. The mobile computing device 650 may also be provided with a storage device, such as a micro-drive or other device, to provide additional storage. Each of the processor 652, the memory 664, the display 654, the communication interface 666, and the transceiver 668, are interconnected using various buses, and several of the components may be mounted on a common motherboard or in other manners as appropriate. In some implementations, the mobile computing device 650 may include a camera device(s).

The processor 652 can execute instructions within the mobile computing device 650, including instructions stored in the memory 664. The processor 652 may be implemented as a chipset of chips that include separate and multiple analog and digital processors. For example, the processor 652 may be a Complex Instruction Set Computers (CISC) processor, a Reduced Instruction Set Computer (RISC) processor, or a Minimal Instruction Set Computer (MISC) processor. The processor 652 may provide, for example, for coordination of the other components of the mobile computing device 650, such as control of user interfaces (UIs), applications run by the mobile computing device 650, and/or wireless communication by the mobile computing device 650.

The processor 652 may communicate with a user through a control interface 658 and a display interface 656 coupled to the display 654. The display 654 may be, for example, a Thin-Film-Transistor Liquid Crystal Display (TFT) display, an Organic Light Emitting Diode (OLED) display, or other appropriate display technology. The display interface 656 may include appropriate circuitry for driving the display 654 to present graphical and other information to a user. The control interface 658 may receive commands from a user and convert them for submission to the processor 652. In addition, an external interface 662 may provide communication with the processor 652, so as to enable near area communication of the mobile computing device 650 with other devices. The external interface 662 may provide, for example, for wired communication in some implementations, or for wireless communication in other implementations, and multiple interfaces may also be used.

The memory 664 stores information within the mobile computing device 650. The memory 664 can be implemented as one or more of a computer-readable medium or media, a volatile memory unit or units, or a non-volatile memory unit or units. An expansion memory 674 may also be provided and connected to the mobile computing device 650 through an expansion interface 672, which may include, for example, a Single in Line Memory Module (SIMM) card interface. The expansion memory 674 may provide extra storage space for the mobile computing device 650, or may also store applications or other information for the mobile computing device 650. Specifically, the expansion memory 674 may include instructions to carry out or supplement the processes described above, and may include secure information also. Thus, for example, the expansion memory 674 may be provided as a security module for the mobile computing device 650, and may be programmed with instructions that permit secure use of the mobile computing device 650. In addition, secure applications may be provided via the SIMM cards, along with additional information, such as placing identifying information on the SIMM card in a non-hackable manner.

The memory may include, for example, flash memory and/or non-volatile random access memory (NVRAM), as discussed below. In some implementations, instructions are stored in an information carrier. The instructions, when executed by one or more processing devices, such as processor 652, perform one or more methods, such as those described above. The instructions can also be stored by one or more storage devices, such as one or more computer-readable or machine-readable mediums, such as the memory 664, the expansion memory 674, or memory on the processor 652. In some implementations, the instructions can be received in a propagated signal, such as, over the transceiver 668 or the external interface 662.

The mobile computing device 650 may communicate wirelessly through the communication interface 666, which may include digital signal processing circuitry where necessary. The communication interface 666 may provide for communications under various modes or protocols, such as Global System for Mobile communications (GSM) voice calls, Short Message Service (SMS), Enhanced Messaging Service (EMS), Multimedia Messaging Service (MMS) messaging, code division multiple access (CDMA), time division multiple access (TDMA), Personal Digital Cellular (PDC), Wideband Code Division Multiple Access (WCDMA), CDMA2000, General Packet Radio Service (GPRS). Such communication may occur, for example, through the transceiver 668 using a radio frequency. In addition, short-range communication, such as using a Bluetooth or Wi-Fi, may occur. In addition, a Global Positioning System (GPS) receiver module 670 may provide additional navigation-and location-related wireless data to the mobile computing device 650, which may be used as appropriate by applications running on the mobile computing device 650.

The mobile computing device 650 may also communicate afudibly using an audio codec 660, which may receive spoken information from a user and convert it to usable digital information. The audio codec 660 may likewise generate audible sound for a user, such as through a speaker, e.g., in a handset of the mobile computing device 650. Such sound may include sound from voice telephone calls, may include recorded sound (e.g., voice messages, music files, etc.) and may also include sound generated by applications operating on the mobile computing device 650.

The mobile computing device 650 may be implemented in a number of different forms, as shown in FIG. 6. For example, it may be implemented a phone device 680, a personal digital assistant 682, and a tablet device (not shown). The mobile computing device 650 may also be implemented as a component of a smart-phone, AR device, or other similar mobile device.

Computing device 600 and/or 650 can also include USB flash drives. The USB flash drives may store operating systems and other applications. The USB flash drives can include input/output components, such as a wireless transmitter or USB connector that may be inserted into a USB port of another computing device.

Other embodiments and applications not specifically described herein are also within the scope of the following claims. Elements of different implementations described herein may be combined to form other embodiments not specifically set forth above. Elements may be left out of the structures described herein without adversely affecting their operation. Furthermore, various separate elements may be combined into one or more individual elements to perform the functions described herein.

1. A system comprising:
an array of sensors configured to capture data about an environment for vehicular traffic, the array of sensors disposed at a non-vehicular location; and
one or more computing devices comprising one or more processors, wherein the one or more processors are configured to:
process the captured data about the environment to detect one or more road users in the environment and/or to detect information about traffic signage in the environment, and
transmit, in real-time, an indication of the one or more detected road users and/or the detected information about the traffic signage in the environment to a vehicle.

2. The system of claim 1, wherein the one or more processors are further configured to identify static or dynamic terrain information about the environment.

3. The system of claim 1, wherein transmitting the indication of the one or more detected road users and/or the detected information about the traffic signage in the environment to the vehicle comprises transmitting the indication directly to the vehicle.

4. The system of claim 1, wherein transmitting the indication of the one or more detected road users and/or the detected information about the traffic signage in the environment to the vehicle comprises transmitting the indication to the vehicle via a cloud server.

5. A system comprising:
an array of sensors configured to capture data about an environment for vehicular traffic, the array of sensors disposed remotely from the vehicle; and
one or more computing devices comprising one or more processors, wherein the one or more processors are configured to:
process the captured data about the environment to detect one or more road users in the environment and/or to detect information about traffic signage in the environment, and
transmit, in real-time, an indication of the one or more detected road users and/or the detected information about the traffic signage in the environment to a service provider that provides real-time alerts and/or analytics to vehicle owners based on the transmitted indication.

6. The system of claim 5, wherein the one or more processors are further configured to identify static or dynamic terrain information about the environment.

7. The system of claim 5, wherein transmitting the indication of the one or more detected road users and/or the detected information about the traffic signage in the environment to the service provider comprises transmitting the indication directly to the service provider.

8. The system of claim 1, wherein transmitting the indication of the one or more detected road users and/or the detected information about the traffic signage in the environment to the service provider comprises transmitting the indication to the service provider via a cloud server.

9. The system of claim 1, wherein the real-time alerts and/or analytics relate to traffic management, predictive maintenance, and/or safety notifications.

10. A method comprising:
capturing data about an environment for vehicular traffic using an array of sensors;
processing the captured data, using one or more processors, to detect one or more road users in the environment and/or to detect information about traffic signage in the environment; and
transmitting, in real-time, an indication of the one or more detected road users and/or the detected information about the traffic signage in the environment to a vehicle in the road environment.

11. The method of claim 10, comprising processing the captured data, using the one or more processors, to identify static or dynamic terrain information about the environment.

12. The method of claim 10, wherein transmitting the indication of the one or more detected road users and/or the detected information about the traffic signage in the environment to the vehicle comprises transmitting the indication directly to the vehicle.

13. The method of claim 10, wherein transmitting the indication of the one or more detected road users and/or the detected information about the traffic signage in the environment to the vehicle comprises transmitting the indication to the vehicle via a cloud server.

14-21. (canceled)
